(19) United States
(12) Patent Application Publication
(10) Pub. No.: US 2010/0140309 A1
(43) Pub. Date: Jun. 10, 2010

(54) LUGGAGE CONTAINER FOR TWO-WHEELED VEHICLES, TRIKES, AND QUADS

(76) Inventors: David JENNI, Winterthur (CH); Christoph VON OW, Wadenswil (CH)

Correspondence Address: OSTROLENK FABER GERB & SOFFEN, 1180 AVENUE OF THE AMERICAS, NEW YORK, NY, 100368403, US

(21) Appl. No.: 12/627,265

(22) Filed: Nov. 30, 2009

(30) Foreign Application Priority Data
Dec. 9, 2008 (CH) 01933/08

(51) Int. Cl. B62J 7/00; A45C 7/00

(52) U.S. Cl. 224/463; 190/105

(57) ABSTRACT

The luggage container is suited for two-wheeled vehicles, trikes, and quads. It comprises at least two planar walls that can be nested in a telescoping manner such that the volume of the luggage container can be infinitely adjusted by way of adjusting means. In each case, two adjoining nestable walls are connected to each other by an interposed membrane. By nesting the walls, the top of the luggage container can be lashed to the bottom using Velcro fastener belts or belts with buckles to any desired volume between the fully expanded and the fully collapsed state.

### BACKGROUND OF THE INVENTION

The invention relates to a luggage container for two-wheeled vehicles, trikes, and quads.

Most luggage containers for two-wheeled vehicles, trikes, or quads have a fixed volume, which cannot be varied. This has tremendous disadvantages for the user. First, the user cannot adapt the volume to the nature and duration of a planned trip. As a result, he will have to own luggage containers of various sizes, which he will use depending on the duration and nature of the planned trip. Or, he will tend to own a luggage container that is too large, which he will then fill only partially in most instances. As a result of incomplete filling, the objects packed in the luggage container are stored loosely and may therefore negatively impact the stability of a motorcycle, for example. Secondly, a luggage container having a non-variable volume cannot be adapted to the changing needs during a trip. A frequent example for the changing needs includes the daily purchases that are done during a trip when traveling with such a two-wheeled vehicle, trike, and quad. The purchases are then put away in the parking lot of the store, but are consumed little by little thereafter and therefore no longer take up space in the luggage container. The items remaining in it are stored only loosely.

From DE 30 27 453 A1, a tank bag for motorcycles is known, the volume of which can be varied to two or more defined sizes. In order to vary the volume, the tank bag has a foldable peripheral wall, which can be collapsed by closing a slide fastener or opened by opening the same. Such luggage containers have the disadvantage that the user has only a defined number of different volumes (typically two) at his disposal, while often infinitely variable adjustment would be desirable. A further disadvantage of such a luggage container is that the foldable peripheral wall has to be folded inward when reducing the volume, wherein typically the objects transported inside the luggage container are in the way. Another disadvantage of such a luggage container is that the foldable peripheral wall is not reinforced in the opened state and the objects stored in this region of the luggage container are not laterally fixed. If the objects are heavy, this may result in unstable handling, and in extreme cases even in accidents.

### OBJECT OF THE INVENTION

It is the object of the invention to improve a luggage container of this type for two-wheeled vehicles, trikes, and quads such that the volume can be infinitely adjusted.

The invention will be described in more detail below with reference to figures, which illustrate only one exemplary embodiment. Shown are:

### BRIEF DESCRIPTION OF THE DRAWINGS

FIG. 1 A luggage container in the fully collapsed state (perspective view),

FIG. 2 A luggage container in the fully expanded state (perspective view),

FIG. 3 A luggage container in the fully collapsed state (sectional view),

FIG. 4 A luggage container in the fully expanded state (sectional view),

FIG. 5 An example of an adjusting means having lashing straps (with Velcro material) and eyelets,

FIG. 6 An example of an adjusting means having lashing straps (without Velcro material) and clamping buckles,

FIG. 7 Application examples comprising a luggage container mounted on a tank and a luggage container mounted on a luggage carrier,

FIG. 8 A luggage container comprising three nestable walls (perspective view).

### DESCRIPTION OF PREFERRED EMBODIMENTS

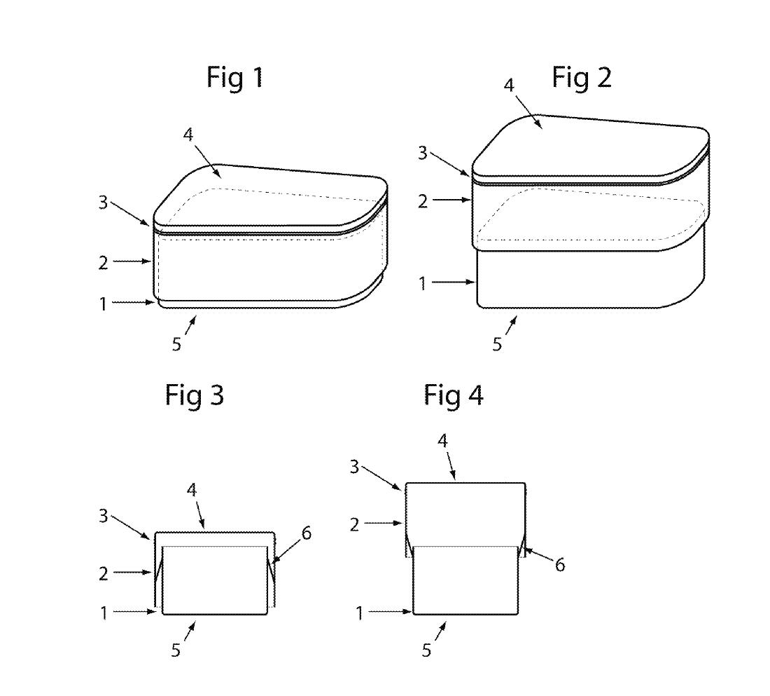

The luggage container according to the invention comprises two peripheral, planar walls 1, 2, which are shown in FIGS. 1 to 4, which can be positively nested in each other in a telescoping manner such that the volume of the luggage container can be infinitely varied. FIGS. 1 and 3 show the luggage container in the fully collapsed state thereof, in which it has the minimum volume that can be set. FIGS. 2 and 4 show the luggage container in the fully expanded state thereof, in which it has the maximum volume possible. An infinite number of volumes can be set between these two states.

The walls 1, 2 are designed to be rigid, semi-rigid, or reinforced. Possible embodiments include walls in the form of hard shells made of plastic, double-walled textile walls having an interposed planar reinforcement made of plastic, or textile walls having glued, riveted or otherwise connected planar reinforcements made of plastic. Instead of plastic, it is also possible to use any other rigid or semi-rigid material, such as metal, cardboard, or a composite material. For the purpose of weight optimization, the hard shells or planar reinforcements may be provided with apertures such that they appear, for example, like a perforated plate.

A bottom 5, which constitutes a downward closure of the luggage container, adjoins at the lower end of the inner nestable wall 1. A cover 4, which constitutes an upward closure of the luggage container, adjoins at the upper end of the outer nestable wall 2. For easier filling of the luggage container, a zipper 3 is installed such that after being opened the cover 4 can be folded along three sides over the remaining closed side.

A variant of the luggage container as shown in FIGS. 3 and 4 is particularly advantageous, wherein two adjoining walls 1, 2 in each case are connected by a membrane 6. If the walls 1, 2, bottom 5, cover 4, and also the membrane 6 are made of waterproof material, and if they are connected to each other along the periphery in a waterproof manner, for example by means of a welded seam, and if also the zipper 3 is designed to be waterproof, the entire luggage container is waterproof.

If the membrane 6 is fastened between the walls 1, 2 such that in the fully collapsed state of the luggage container it is tensioned on the inside thereof such that the edge thereof fastened to the outer wall 2 is at the bottom, the minimum volume that can be achieved is limited by the membrane 6, and a differently designed stop may be foregone, as is apparent from FIG. 3.

If the membrane 6 is furthermore fastened between the walls 1, 2 such that in the fully expanded state of the luggage container it is tensioned such that the edge thereof fastened to the outer wall 2 is at the top, the maximum volume that can be achieved is also limited by the membrane 6, and a differently designed limitation of the maximum travel may be foregone, as is apparent from FIG. 4. In this way, it can be assured at all times that the walls overlap and the objects stored in the luggage container are laterally sufficiently fixed.

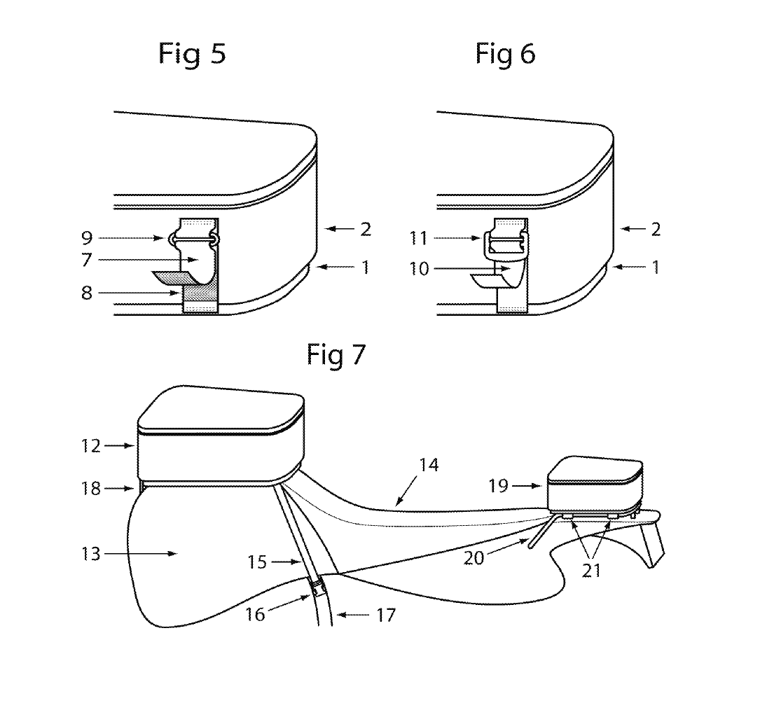

Particularly advantageous is a variant of the luggage container as shown in FIGS. 5 and 6, wherein in all positions the volume can be limited in keeping with the current needs by way of adjusting means.

A possible embodiment of such adjusting means includes lashing straps 7 to which Velcro material 8 is applied, and which are permanently connected to the inner nestable wall 1 and are diverted 180° through eyelets 9 fastened to the outer nestable wall 2, as is shown in FIG. 5. By opening the Velcro fastening and pulling on the lashing straps, the nestable walls 1, 2 can be lashed together. This lashed-together state can subsequently be secured by closing the Velcro fastening. By opening the Velcro fastening, the volume limitation can be removed and the luggage container can be arbitrarily expanded.

Another possible embodiment of such adjusting means includes lashing strips 10, which are fastened to the inner nestable wall 1 and which are guided by clamping buckles 11 fastened to the outer nestable wall 2, as is shown in FIG. 6. By pulling on the lashing straps 10, the nestable walls 1, 2 can be lashed together. The lashing straps 10 can be loosened by lifting the clamping buckles 11, and the luggage container can be arbitrarily expanded.

A particularly advantageous variant of the luggage container is one which is already provided with installation means for fastening to a two-wheeled vehicle, trike, or quad, as is shown in FIG. 7, for example.

A possible embodiment of such installation means includes belts 15, 18 on both sides, comprising buckles 16 that can be latched into corresponding counter-pieces fastened to the vehicle frame 17.

Another possible embodiment of such installation means includes belts 21, which are wrapped directly around parts of the luggage container 20 or the vehicle frame. Such belts may be tensioned and secured by buckles or Velcro straps fastened to the luggage container, or they can also be tied thereto.

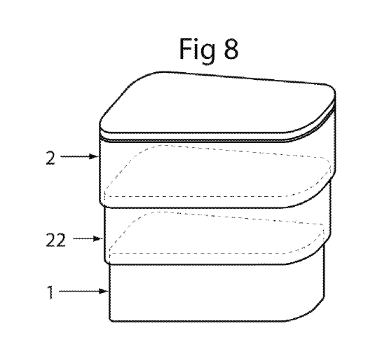

FIG. 8 shows an embodiment of the luggage container, comprising three peripheral, planar walls 1, 2, 22, which can be positively nested in a telescoping manner. In this way, the volume can be adapted within an even larger range. Further embodiments are conceivable, wherein four or even more peripheral, planar walls can be positively nested in a telescoping manner.

Numerous modifications of the exemplary embodiment described are possible, without abandoning the key characteristics of this luggage container. For example, the nestable walls may be disposed such that the bottom 5 is fastened to the outer wall 2 and the cover 4 to the inner wall 1. It is likewise conceivable to fasten the zipper 3 between the bottom and the wall such that the entire luggage container can be folded down from the bottom. Instead of the zipper, an arbitrary different closure may be used. The membrane 6 may be made of elastic material.

In addition, numerous modifications of the adjusting means described are possible, without abandoning the key characteristics of the luggage container. For example, Velcro material may be applied directly between the nestable walls 1, 2 such that the walls can no longer displaced relative to each other when the Velcro fastening is closed. Mechanisms that limit the volume by way of a positive connection are likewise possible. Such mechanism can be configured, for example, as snap fasteners or as toothed racks on one wall, with corresponding detachable or elastic abutments being provided on the other wall. The adjusting means may also be designed as clamps, which are fastened to one wall and run through profiles fastened to the other wall.

Numerous modifications of the installation means described are possible, without abandoning the key characteristics of the luggage container. For example, the belts 15, 18 can be engaged in the vehicle frame by way of a hook. Likewise, it is possible to design the ends of the belts as loops, which are engaged in special counter-pieces attached to the vehicle frame. Furthermore, positive installation means are conceivable, wherein the one counter-piece is connected to the luggage container and the other counter-piece is fastened to the vehicle. Such positive installation means can be designed to be detachable without tools or as a permanent connection between the luggage container and vehicle.

1. A luggage container for two-wheeled vehicles, trikes, and quads, wherein it comprises at least two planar walls that can be nested in a telescoping manner such that the volume of the luggage container can be infinitely adjusted.

2. The luggage container according to claim 1, wherein two adjoining nestable walls are connected to each other by an interposed membrane.

3. The luggage container according to claim 2, wherein the membranes are fastened to the nestable walls such that the maximum volume that can be achieved is defined by the membranes.

4. The luggage container according to claim 2, wherein the membranes are fastened to the nestable walls such that the minimum volume that can be achieved is defined by the membranes.

5. A luggage container according to claim 1, wherein in all adjustment positions the volume of the luggage container can be limited by adjusting means.

6. A luggage container according to claim 1, wherein in all adjustment positions the adjusting means for limiting the volume comprise a lashing strap, to which a Velcro fastening material is applied and which can be lashed and secured by being diverted 180° through an eyelet such that the eyelet acts as a “loose roller”.

7. The luggage container according to claim 1, wherein in all adjustment positions the adjusting means for limiting the volume comprise at least one lashing strap, which can be lashed by a clamping buckle.

8. A luggage container according to claim 1, wherein it comprises installation means for fastening to a motorcycle.

9. A luggage container according to claim 1, wherein it is designed as a tank bag, comprising suitable installation means for fastening to the tank of a motorcycle, trike, or quad.

10. A luggage container according to claim 1, wherein it comprises installation means for fastening to or on a luggage carrier or the seat bench of a two-wheeled vehicle, trike, or quad.
